(19) United States
(12) Patent Application Publication
(10) Pub. No.: US 2026/0233648 A1
(43) Pub. Date: Aug. 13, 2026

(54) AIR-CONDITIONED SEAT FOR VEHICLE

(71) Applicant: TOYOTA BOSHOKU KABUSHIKI KAISHA, Aichi-ken (JP)

(72) Inventor: Satoru OHIRA, Aichi-ken (JP)

(73) Assignee: TOYOTA BOSHOKU KABUSHIKI KAISHA, Aichi-ken (JP)

(21) Appl. No.: 19/536,575

(22) Filed: Feb. 11, 2026

(30) Foreign Application Priority Data
Feb. 12, 2025 (JP) 2025-020624

(51) Int. Cl. B60N 2/58; B60N 2/56

(52) U.S. Cl. CPC B60N 2/5825; B60N 2/5635; B60N 2/5642; B60N 2/565; B60N 2/5685

(57) ABSTRACT

An air-conditioned seat for a vehicle includes a seat back or a seat cushion. The seat back or the seat cushion includes: a pad body having an air flow path leading from a seating surface side to a rear surface side; a support body configured to support the pad body from the rear surface side; and a fan configured to suck air from the air flow path or discharging air to the air flow path through a through hole provided in the support body. A concave-convex shape portion reducing a flow velocity of air flowing through the air flow path is formed in a surface of the pad body in the air flow path which faces the fan.

### CROSS-REFERENCE TO RELATED APPLICATIONS

This application is based on and claims priority under 35 USC 119 from Japanese Patent Application No. 2025-020624 filed on February 12, 2025, the entire content of which is incorporated herein by reference.

### TECHNICAL FIELD

The present disclosure relates to an air-conditioned seat for a vehicle.

### BACKGROUND ART

In the related art, there is an air-conditioned seat that has an air-conditioning function of blowing air toward a body of a seated person or sucking air from around the body of the seated person through an air flow path provided inside a cushion body in a seat for an automobile. In an air-conditioned seat described in JP2019-043292A, a sound absorbing pad formed of a sound absorbing material of urethane foam is disposed between a frame and a blower unit in order to prevent noise generated from the blower unit.

In the air-conditioned seat described in JP2019-043292A, although it is possible to prevent the noise generated from the blower unit, there is a problem that a separate member such as the sound absorbing pad is required to prevent the noise, which leads to an increase in the number of components.

The present disclosure provides an air-conditioned seat for a vehicle in which an increase in the number of components is avoided and noise generated from a blower unit is prevented.

### SUMMARY OF INVENTION

In a first aspect of the present disclosure, an air-conditioned seat for a vehicle includes a seat back or a seat cushion. The seat back or the seat cushion includes: a pad body having an air flow path leading from a seating surface side to a rear surface side; a support body configured to support the pad body from the rear surface side; and a fan configured to suck air from the air flow path or discharging air to the air flow path through a through hole provided in the support body. A concave-convex shape portion reducing a flow velocity of air flowing through the air flow path is formed in a surface of the pad body in the air flow path which faces the fan.

According to the first aspect of the disclosure, it is possible to provide the air-conditioned seat for a vehicle in which, by providing the concave-convex shape portion in a surface of the pad body in the air flow path which faces the fan, a sound wave generated from the fan is refracted and converted into thermal energy, so that noise can be prevented without increasing the number of components. Since the flow velocity of the air flowing through the air flow path can be reduced by the concave-convex shape portion, the air can be rectified to flow, and intake and exhaust efficiency is improved.

In a second aspect of the present disclosure, the air-conditioned seat for a vehicle according to the first aspect of the present disclosure, in which the air flow path is formed by covering, with the support body, a branched groove that is formed in the pad body and that opens toward a side opposite to the seating surface side. The concave-convex shape portion has a wave shape formed of a plurality of concentric circles at a branch point of the groove. The fan faces the concave-convex shape portion through the through hole.

According to the second aspect of the disclosure, since the concave-convex shape portion facing the fan is formed at the branch point of the branched groove, the noise can be prevented more efficiently, and the intake and exhaust efficiency can be improved.

In a third aspect of the present disclosure, the air-conditioned seat for a vehicle according to the second aspect of the present disclosure, in which a rotation axis of the fan is located at a center of the concentric circles.

According to the third aspect of the disclosure, since the concave-convex shape portion is arranged in a well-balanced manner with respect to the flow of air, the noise can be prevented more efficiently, and the intake and exhaust efficiency can be improved.

### BRIEF DESCRIPTION OF DRAWINGS

FIG. 1 is a perspective view of an air-conditioned seat for an automobile according to an embodiment of the present disclosure;

FIG. 2 is an exploded perspective view of a seat back of the air-conditioned seat for an automobile according to the embodiment;

FIG. 3 is a front view of the seat back of the air-conditioned seat for an automobile according to the embodiment. Only a back frame, a main structure, and an airbag device are illustrated;

FIG. 4 is a cross-sectional view taken along a line IV-IV in FIG. 3;

FIG. 5 is an exploded perspective view of the main structure and a fan according to the embodiment. A main cover is omitted;

FIG. 6 is a perspective view of a main pad in the main structure according to the embodiment; and

FIG. 7 is a cross-sectional view of an air-conditioned seat for an automobile in the related art corresponding to FIG. 4.

### DESCRIPTION OF EMBODIMENTS

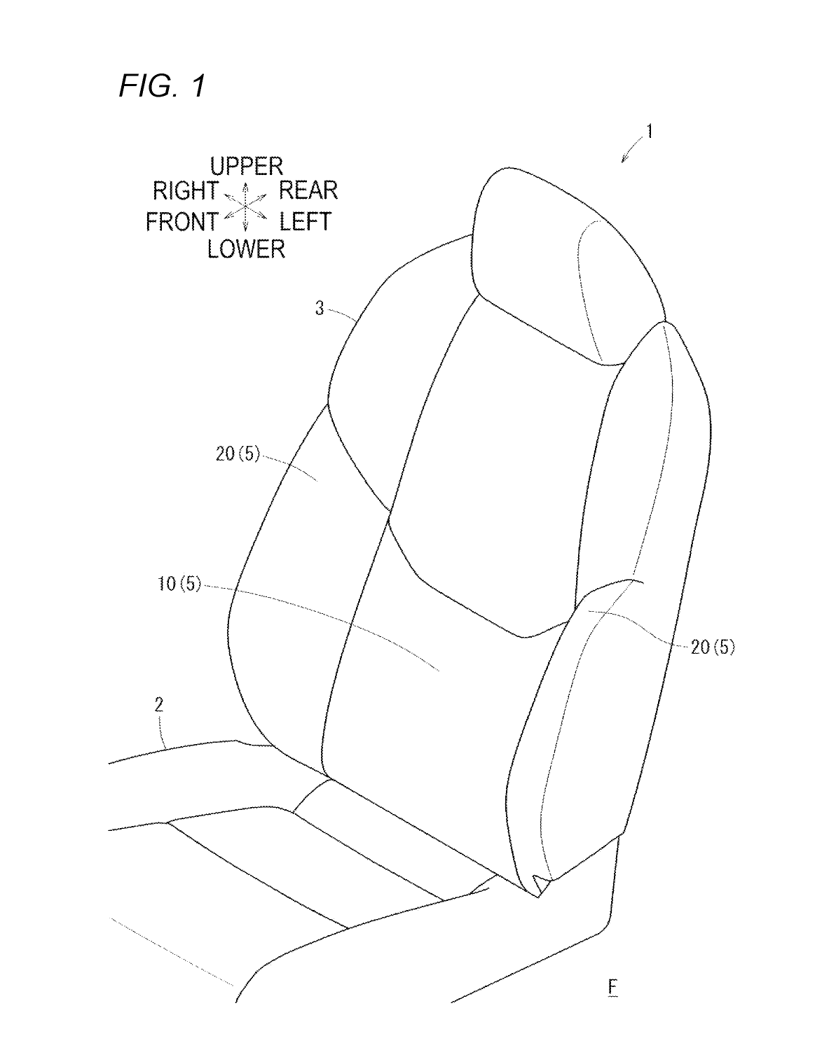

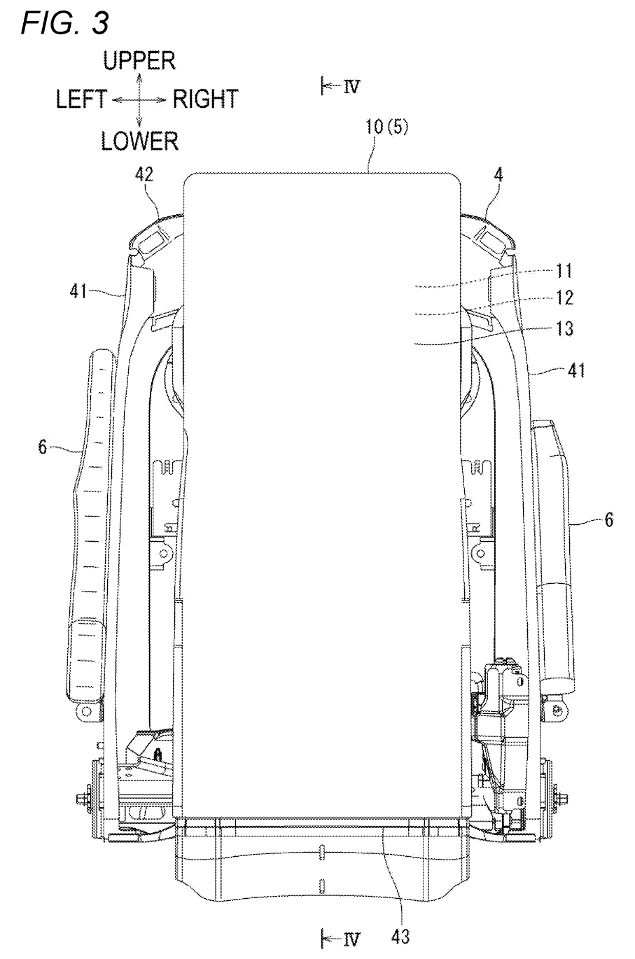

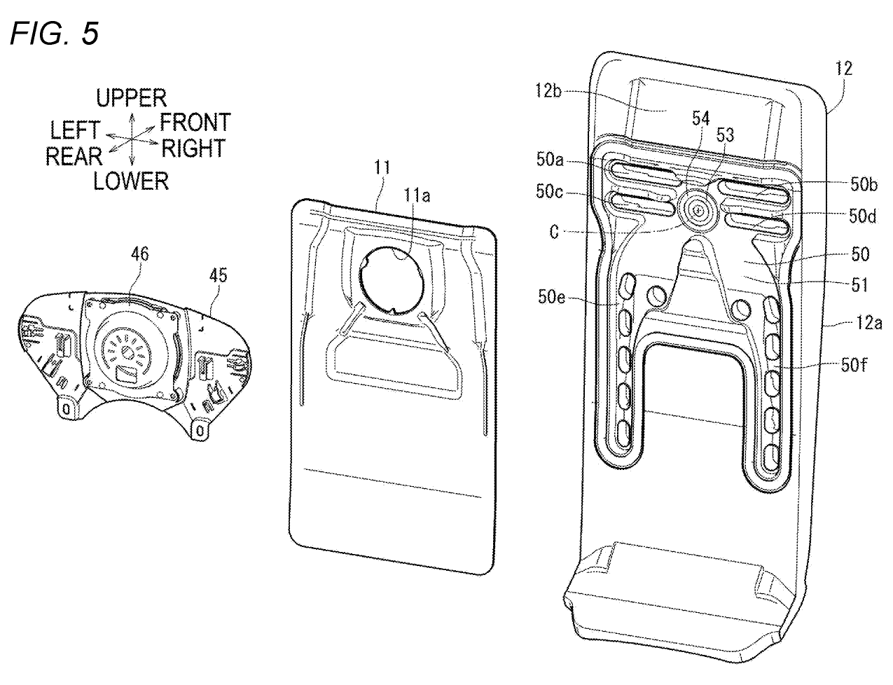

FIGS. 1 to 6 illustrate an embodiment of the present disclosure. This embodiment is an example in which the present disclosure is applied to an air-conditioned seat 1 for an automobile. In each drawing, each of directions when the air-conditioned seat 1 for an automobile is attached to an automobile is indicated by an arrow. In the following description, description relating to the directions will be made with reference to these directions.

The air-conditioned seat 1 for an automobile according to the present embodiment includes a seat cushion 2 serving as a seating portion and a seat back 3 serving as a backrest. Here, the air-conditioned seat 1 for an automobile corresponds to an "air-conditioned seat for a vehicle" in claims.

As illustrated in FIG. 1, the seat back 3 is attached to the seat cushion 2 placed and fixed on a floor F of the automobile. Specifically, a lower end portion of the seat back 3 is attached to a rear end portion of the seat cushion 2 via a recliner 48, and an inclination angle in a front-rear direction with respect to the seat cushion 2 is adjustable.

The seat back 3 includes a back frame 4 forming a framework, a cushion structure 5 that is attached to the back frame 4, that has a cushion function, and that defines an outer shape of the seat back 3, and a pair of left and right airbag devices 6.

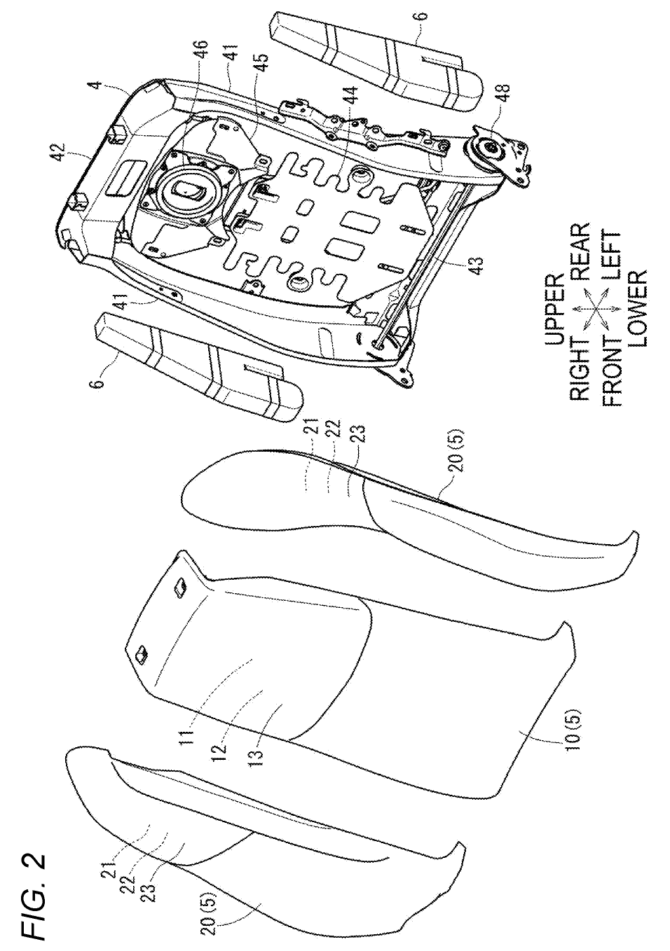

As illustrated in FIGS. 2 to 4, the back frame 4 includes a pair of left and right side frames 41 extending in an up-down direction at both left and right side portions of the seat back 3, an upper frame 42 connecting upper end portions of the side frames 41, and a lower frame 43 connecting lower end portions of the side frames 41. The back frame 4 is formed in a substantially rectangular frame shape when viewed from the front. A lumbar support device 44 is disposed between the upper frame 42 and the lower frame 43 of the back frame 4. The lumbar support device 44 is the same as that disclosed in JP2015-209062A. A fan 46 is attached to the back frame 4 via a fan attachment plate 45 between the upper frame 42 and the lumbar support device 44. The fan 46 is of a type that rotates about a rotation axis A and blows out air, which is sucked from a front side, from outlets 46a at an outer peripheral edge portion in a centrifugal radial manner.

As illustrated in FIGS. 1 and 2, the cushion structure 5 includes a main structure 10 at a central portion in a seat width direction and a pair of left and right side structures 20 at both side portions of the main structure 10. The main structure 10 is a portion that supports a waist and a back of a seated occupant from the rear. The pair of left and right side structures 20 are portions that support the waist and the back of the seated occupant from sides.

As illustrated in FIGS. 2 to 5, the main structure 10 includes a main support member 11 made of a resin and having a substantially plate shape, a main pad 12 that is a cushion body disposed on a front side of the main support member 11 and supported with respect to the back frame 4 by the main support member 11, and a main cover 13 covering the main pad 12 from the front side. Here, the main support member 11 and the main pad 12 correspond to a "support body” and a "pad body" in the claims, respectively.

As illustrated in FIGS. 2 to 5, the main support member 11 has a substantially rectangular shape in which a direction of a long axis is the up-down direction when viewed from the front, and is formed in a surface shape that abuts against a rear surface 12b. The rear surface 12b is a surface opposite to a front surface 12a that is a surface of the main pad 12 on a seated person side. An opening 11a having a circular shape when viewed from the front and penetrating in the front-rear direction is formed in a central portion of an upper portion in a left-right direction. Here, the opening 11a corresponds to a "through hole" in the claims. The front surface 12a and the rear surface 12b correspond to a "seating surface side" and the "rear surface side" in the claims, respectively.

As illustrated in FIGS. 2 to 6, the main pad 12 is an elastic body made of a foamed molded body using a polyurethane resin, and has a substantially rectangular shape in which a direction of a long axis is the up-down direction when viewed from the front. A dimension in the up-down direction is set to be longer than a dimension in the up-down direction of the main support member 11, and a dimension in the left-right direction is set to be substantially the same as a dimension in the left-right direction of the main support member 11. On a side of the rear surface 12b of the main pad 12, six portions radially extending from the central portion of the upper portion in the left-right direction are formed as a recess 50 that opens rearward. A bottom surface portion 51 of the recesses 50 is about half a thickness of the main pad 12 in the front-rear direction. The recess 50 includes an upper left recess 50a, an upper right recess 50b, a middle left recess 50c, a middle right recess 50d, a lower left recess 50e, and a lower right recess 50f. The bottom surface portion 51 includes an upper left bottom surface portion 51a, an upper right bottom surface portion 51b, a middle left bottom surface portion 51c, a middle right bottom surface portion 51d, a lower left bottom surface portion 51e, and a lower right bottom surface portion 51f. The upper left bottom surface portion 51a and the upper right bottom surface portion 51b extend in the left-right direction symmetrically. The middle left bottom surface portion 51c and the middle right bottom surface portion 51d extend in the left-right direction symmetrically. The lower left bottom surface portion 51e extends downward and leftward from the central portion of the upper portion in the left-right direction and extends downward from a point along its path. The lower right bottom surface portion 51f extends downward and rightward from the central portion of the upper portion in the left-right direction and extends downward from a point along its path. The upper left bottom surface portion 51a, the upper right bottom surface portion 51b, the middle left bottom surface portion 51c, and the middle right bottom surface portion 51d are respectively formed with a horizontally elongated round through holes 52a. Each of the horizontally elongated round through holes 52a has an oblong cross section, penetrates in the front-rear direction, and extends in the left-right direction. Each of the lower left bottom surface portion 51e and the lower right bottom surface portion 51f is formed with one round through hole 52b and five vertically elongated round through holes 52c. The round through hole 52b has a circular cross section and penetrates in the front-rear direction. Each of the vertically elongated round through holes 52c has an oblong cross section and penetrates in the front-rear direction. A felt body 12c, which is a nonwoven fabric having a large weight per unit area and is shaped in advance by thermoforming, is integrally foam-molded and disposed on a wall surface portion of the recess 50 when the main pad 12 is molded. The felt body 12c has increased rigidity and is firmly connected by impregnating and solidifying a part of a raw material of the main pad 12 during foam molding of the main pad 12. Accordingly, shape retention of the recess 50 is enhanced. Here, the recess 50, the horizontally elongated round through hole 52a, the round through hole 52b, and the vertically elongated round through hole 52c correspond to an "air flow path" in the claims. The recess 50 corresponds to a "groove" in the claims.

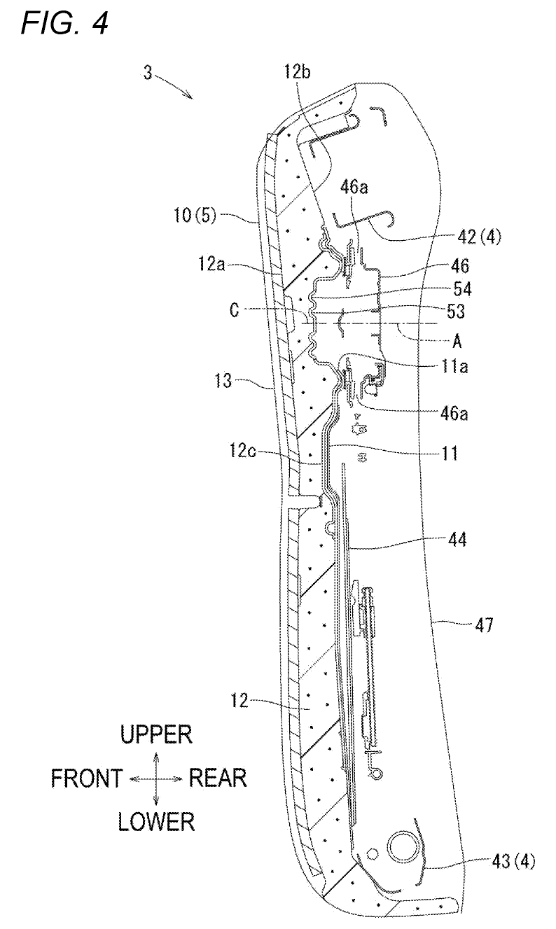

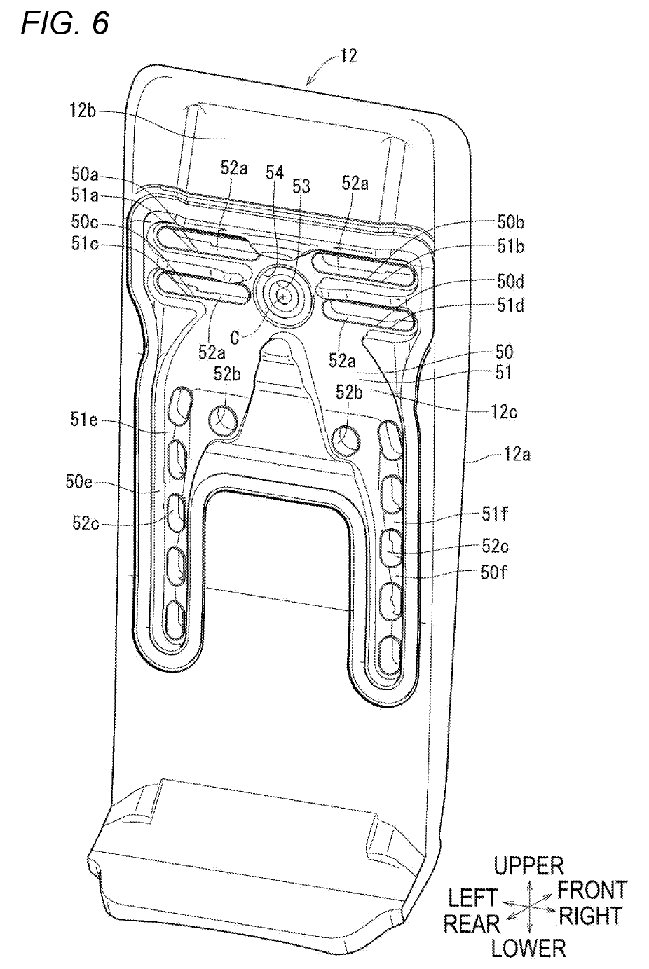

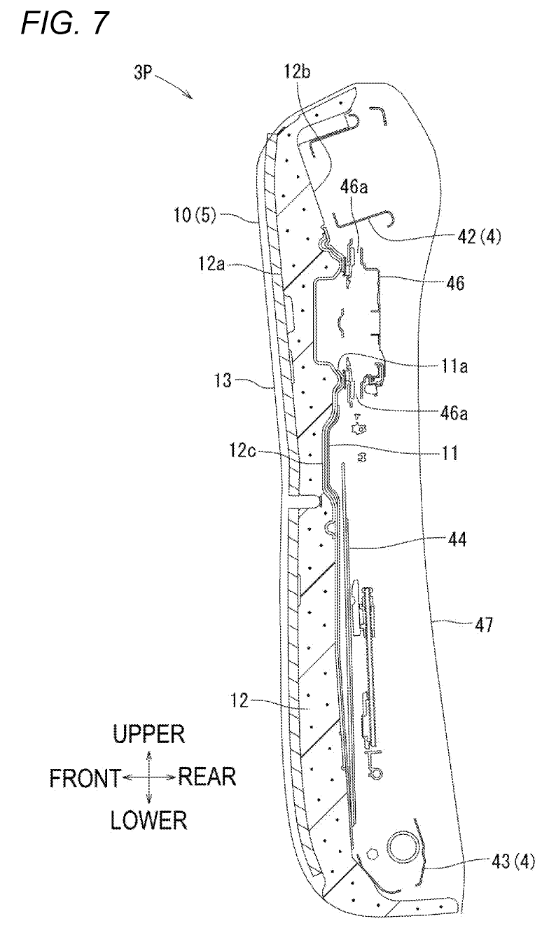

As illustrated in FIGS. 4 to 6, a small circular recess 53 and a large circular recess 54 are formed in the central portion in the left-right direction of the upper portion of the main pad 12 in the bottom surface portion 51. The small circular recess 53 has a circular shape centered on a center point C and opens rearward. The large circular recess 54 has a circular shape centered on the center point C and opens rearward. Since each of the small circular recess 53 and the large circular recess 54 has a substantially U-shaped cross section, a cross section passing through the center point C has a wavy shape (see FIG. 6). As compared with a cross section of a seat back 3P of an air-conditioned seat for an automobile in the related art illustrated in FIG. 7, the seat back 3 is different from the seat back 3P only in that the small circular recess 53 and the large circular recess 54 are provided in the central portion in the left-right direction of the upper portion of the main pad 12 in the bottom surface portion 51. Here, the small circular recess 53 and the large circular recess 54 correspond to a "concave-convex shape portion" in the claims. Further, the central portion of the upper portion in the left-right direction in which the small circular recess 53 and the large circular recess 54 are formed corresponds to a "branch point" in the claims. The center point C corresponds to a "center" in the claims.

As illustrated in FIGS. 2 to 4, the main cover 13 is a bag-shaped cover member that is formed by integrating a plurality of pieces by sewing and that opens rearward. The plurality of pieces are formed by cutting a planar body obtained by laminating a thin urethane slab pad on a fabric. The main structure 10 is formed by covering the main pad 12 disposed on the front side of the main support member 11 with the main cover 13 from a front surface 12a side and engaging an end portion of a rear opening of the main cover 13 with an end portion of the main support member 11.

The main structure 10 is assembled by covering the main cover 13 from the front surface 12a side of the main pad 12 and engaging the end portion of the rear opening of the main cover 13 with the end portion of the main support member 11 in a state in which a front surface of the main support member 11 abuts against the rear surface 12b of the main pad 12. At this time, as illustrated in FIG. 4, the opening 11a of the main support member 11 faces the central portion in the left-right direction of the upper portion of the main pad 12 in the bottom surface portion 51, and a center of the opening 11a coincides with the center point C of the main pad 12. Accordingly, a rear opening of the recess 50 of the main pad 12 is covered by the main support member 11, and a space between the bottom surface portion 51 and the main support member 11 becomes a part of the air flow path.

As illustrated in FIG. 2, the side structure 20 includes a side support member 21 made of a resin, a side pad 22 that is a cushion body disposed on a front side of the side support member 21 and supported with respect to the back frame 4 by the side support member 21, and a side cover 23 covering the side pad 22 from the front side. The side support member 21 is a substantially plate-shaped member made of the resin similar to the main support member 11. The side pad 22 is an elastic body made of a foamed molded body using a polyurethane resin similar to the main pad 12, and has an outer shape that is substantially the same as that of the side support member 21 when viewed from the front. Similar to the main cover 13, the side cover 23 is a bag-shaped cover member that is formed by integrating a plurality of pieces by sewing and that opens rearward. The plurality of pieces are formed by cutting a planar body obtained by laminating a thin urethane slab pad on a fabric. the side structure 20 is formed by covering the side pad 22 disposed on the front side of the side support member 21 with the side cover 23 from the front side and engaging an end portion of a rear opening of the side cover 23 with a rear surface portion of an outer peripheral edge of the side support member 21.

An assembly procedure of the seat back 3 will be described. First, as illustrated in FIGS. 2 to 4, the lumbar support device 44 is disposed between the side frames 41 of the back frame 4 so as to bridge the upper frame 42 and the lower frame 43. Then, the airbag devices 6 are respectively attached to side surfaces in outer sides in the seat width direction of the side frames 41. Subsequently, the left and right side structures 20 assembled in advance are attached to the back frame 4 by fixing predetermined positions of the side support members 21 with screws. Next, the main structure 10 assembled in advance is attached to the back frame 4 such that a rear surface of the main support member 11 abuts against a front surface of the fan attachment plate 45 and a front surface of the lumbar support device 44. At this time, the center point C of the main pad 12 in the main structure 10 is located on an extension line of the rotation axis A of the fan 46. Then, an upper portion of the main support member 11 is fixed to the upper frame 42, and a lower portion of the main support member 11 is fixed to a rear surface portion of the lower frame 43.

The seat back 3 assembled as described above is assembled to the seat cushion 2 to form the air-conditioned seat 1 for an automobile. The air-conditioned seat 1 for an automobile has the following effects. As illustrated in FIG. 4, when the fan 46 is operated, the air on the front side of the seat back 3, that is, the seating surface side flows through the main cover 13 to the horizontally elongated round through holes 52a, the round through holes 52b, and the vertically elongated round through holes 52c, passes through the recess 50, enters the fan 46 from the opening 11a, and is discharged in a radial direction from the outlets 46a of the fan 46. The small circular recess 53 and the large circular recess 54 centered on the center point C are formed in a portion of the bottom surface portion 51 of the recess 50 which faces the fan 46. Accordingly, a sound wave generated from the fan 46 is refracted and converted into thermal energy, so that noise can be prevented without increasing the number of components. Since a flow velocity of the air flowing in the recess 50 can be reduced by the small circular recess 53 and the large circular recess 54, the air can be rectified to flow, and intake and exhaust efficiency is improved. The air discharged from the outlets 46a of the fan 46 is discharged to the outside of the seat back 3 from an opening (not illustrated) between a lower portion of the main cover 13 and a lower portion of a backboard 47.

The small circular recess 53 and the large circular recess 54 are formed in the central portion of the upper portion in the left-right direction. The central portion of the upper portion in the left-right direction is the branch point where the six portions (the upper left recess 50a, the upper right recess 50b, the middle left recess 50c, the middle right recess 50d, the lower left recess 50e, and the lower right recess 50f) radially extend. The small circular recess 53 and the large circular recess 54 are formed of concentric circles that have the cross section having the wavy shape. Accordingly, the noise can be prevented more efficiently, and the intake and exhaust efficiency can be improved.

The center point C of the small circular recess 53 and the large circular recess 54 is located on the extension line of the rotation axis A of the fan 46. Accordingly, since the small circular recess 53 and the large circular recess 54 are arranged in a well-balanced manner with respect to the flow of air, the noise can be prevented more efficiently, and the intake and exhaust efficiency can be improved.

Although a specific embodiment has been described above, the present disclosure is not limited to the appearance and configuration thereof, and various modifications, addition, and deletion can be made without changing the gist of the present disclosure. Examples thereof include the following.
1. In the above embodiment, the air taken in from the front side of the seat back 3 flows into the horizontally elongated round through holes 52a, the round through holes 52b, and the vertically elongated round through holes 52c, passes through the recess 50, enters the fan 46 from the opening 11a, and is discharged in the radial direction from the outlets 46a of the fan 46. However, the present disclosure is not limited thereto, and the present disclosure may be configured such that the air sent out from the fan 46 flows from the opening 11a through the recess 50 to the horizontally elongated round through holes 52a, the round through holes 52b, and the vertically elongated round through holes 52c and is discharged from the front side of the seat back 3.
2. In the above embodiment, two circular recesses of the small circular recess 53 and the large circular recess 54 corresponding to the "concave-convex shape portion" are provided, but the present disclosure is not limited thereto, and three or more concentric circular recesses may be provided.
3. In the above embodiment, the present disclosure is applied to a seat of an automobile, but may be applied to a seat mounted on an airplane, a ship, a train, or the like.

What is claimed is:

1. An air-conditioned seat for a vehicle comprising a seat back or a seat cushion,
wherein the seat back or the seat cushion includes:
a pad body having an air flow path leading from a seating surface side to a rear surface side;
a support body configured to support the pad body from the rear surface side; and
a fan configured to suck air from the air flow path or discharging air to the air flow path through a through hole provided in the support body, and
wherein a concave-convex shape portion reducing a flow velocity of air flowing through the air flow path is formed in a surface of the pad body in the air flow path which faces the fan.

2. The air-conditioned seat for a vehicle according to claim 1,
wherein the air flow path is formed by covering, with the support body, a branched groove that is formed in the pad body and that opens toward a side opposite to the seating surface side,
wherein the concave-convex shape portion has a wave shape formed of a plurality of concentric circles at a branch point of the groove, and
wherein the fan faces the concave-convex shape portion through the through hole.

3. The air-conditioned seat for a vehicle according to claim 2,
wherein a rotation axis of the fan is located at a center of the concentric circles.
